(19) United States
(12) Patent Application Publication
(10) Pub. No.: US 2025/0189754 A1
(43) Pub. Date: Jun. 12, 2025

(54) OPTICAL APPARATUS AND IMAGING SYSTEM

(71) Applicant: CANON KABUSHIKI KAISHA, Tokyo (JP)

(72) Inventor: REMI IWAMOTO, Tochigi (JP)

(21) Appl. No.: 18/966,935

(22) Filed: Dec. 3, 2024

(30) Foreign Application Priority Data
Dec. 8, 2023 (JP) 2023-207791

(51) Int. Cl. G02B 7/09

(52) U.S. Cl. CPC G02B 7/09

(57) ABSTRACT

An optical apparatus comprises first holding member, first guide member and second guide member, and first biasing member. The first holding member includes first linear guide portion, and first regulating portion. Sliding surface of the first linear guide portion exists in a range of ±90 degrees around first axis from intersection between straight line drawn from center of the first axis and outer peripheral surface of the first guide member in reaction force direction of resultant force formed by first force applied to the first holding member by the first biasing member and second force received by the first regulating portion from the second guide member. The first linear guide portion has a cutout portion in a range not including the sliding surface. A part of the first guide member exists in the cutout portion. The first guide member is disposed so as to overlap the first linear guide portion.

### BACKGROUND

### Technical Field

The present disclosure relates to an optical apparatus and an imaging system.

### Description of the Related Art

A lens barrel having a mechanism for moving a lens unit using an electric driving unit and an image pickup apparatus including the lens barrel are known.

Japanese Patent Application Laid-Open No. 2022-169960 discloses a configuration in which, in order to reduce the size of a lens barrel, a single biasing member is used to eliminate backlash between a transmission member connected to a linear ultrasonic motor and backlash between a lens holding member and a guide bar.

In the configuration disclosed in Japanese Patent Application Laid-Open No. 2022-169960, the fitting portion into which the guide bar is fitted is a sleeve hole (cylindrical shape), and it is necessary to arrange the peripheral members in consideration of the cylindrical portion. Therefore, it is difficult to further reduce the size.

### SUMMARY

The present disclosure features an optical apparatus comprising: a first holding member configured to hold a first movable lens unit, a first guide member and a second guide member that guide the first holding member in an optical axis direction, a first driving unit configured to drive the first holding member in the optical axis direction, a first coupling member configured to transmit a driving force of the first driving unit to the first holding member, and a first biasing member configured to bias the first holding member and the first driving unit and to bias the first holding member and the first guide member, wherein the first holding member includes a first linear guide portion which contacts the first guide member and is guided along a first axis parallel to an optical axis, and a first regulating portion which contacts the second guide member, wherein a sliding surface of the first linear guide portion that slides with respect to the first guide member exists in a range of ±90 degrees around the first axis from an intersection between a straight line drawn from a center of the first axis and an outer peripheral surface of the first guide member in a reaction force direction of a resultant force formed by a first force applied to the first holding member by the first biasing member and a second force received by the first regulating portion from the second guide member, wherein the first linear guide portion has a cutout portion in a range not including the sliding surface viewed in the optical axis direction, and wherein the first guide member or the other member is disposed so as to overlap the first linear guide portion viewed in a direction orthogonal to the optical axis.

Further features of the present disclosure will become apparent from the following description of exemplary embodiments with reference to the attached drawings.

### BRIEF DESCRIPTION OF THE DRAWINGS

FIG. 1 is a cross-sectional view of the imaging system (30) according to the embodiment 1.

FIG. 2A is an exploded perspective view of a 4A lens barrel (122) and peripheral members according to the embodiment 1. FIG. 2B is a perspective view of a configuration in which peripheral members are assembled to the 4A lens barrel (122) viewed from another viewpoint.

FIG. 3 is a front view of a configuration in which peripheral members are assembled to the 4A lens barrel (122) according to the embodiment 1.

FIG. 4 is a front view illustrating forces acting on the 4A lens barrel (122) according to the embodiment 1.

FIG. 5 is an enlarged view of a range (A) indicated by a broken line in FIG. 4.

FIG. 6A is a front view of the arrangement of the 4A lens barrel (122) and the fifth lens barrel (127) according to the embodiment 1 viewed from the imaging surface side. FIG. 6B is a side view of the same arrangement.

FIG. 7 is a front view of a configuration in which the 4A lens barrel (122) is assembled to the third base lens barrel (120) according to the embodiment 1 viewed from the imaging surface side.

FIG. 8 is an enlarged view of a linear guide portion (122G) according to a modification 1 of the linear guide portion (122G) according to the embodiment 1.

FIG. 9 is a front view illustrating a modification 2 of the rotation regulating portion (122f) of the 4A lens barrel (122) according to the embodiment 1 viewed from the imaging surface side.

FIG. 10 is a perspective view illustrating a modification 3 of the driving unit of the 4A lens barrel (122) according to the embodiment 1.

FIG. 11 is a front view illustrating a modification 4 of the guide member (123a) according to the embodiment 1 viewed from the imaging surface side.

FIG. 12 is an enlarged view of a range (A) indicated by a broken line in FIG. 11.

FIG. 13 is a cross-sectional view of the lens barrel 10 according to the embodiment 2.

FIG. 14 is an exploded perspective view of the 4A lens barrel (122), a 4B lens barrel (222), and peripheral members according to the embodiment 2.

FIG. 15A is a front view of a configuration in which the 4A lens barrel (122) and the 4B lens barrel (222) are assembled to the peripheral members viewed from the imaging surface side according to the embodiment 2. FIG. 15B is a front view viewed from the object side.

FIG. 16 is an enlarged view of a range (C) indicated by a broken line in FIG. 15B.

FIG. 17 is a front view of a configuration in which the 4A lens barrel (122) and the 4B lens barrel (222) are assembled to the third base lens barrel (120) viewed from the imaging surface side according to the embodiment 2.

FIG. 18A is a cross-sectional view taken along a cross-sectional line E-E in FIG. 15A in a state where the distance between the 4A lens barrel (122) and the 4B lens barrel (222) is maximum. FIG. 18B is a cross-sectional view in a state where the distances are minimum.

FIG. 19 is an enlarged view illustrating a modification 5 of a linear guide portion (222G) of the 4B lens barrel (222) according to the embodiment 2.

FIG. 20 is a perspective view illustrating a modification 6 of the driving unit of the 4A lens barrel (122) according to the embodiment 2.

### DESCRIPTION OF THE EMBODIMENTS

### Embodiment 1

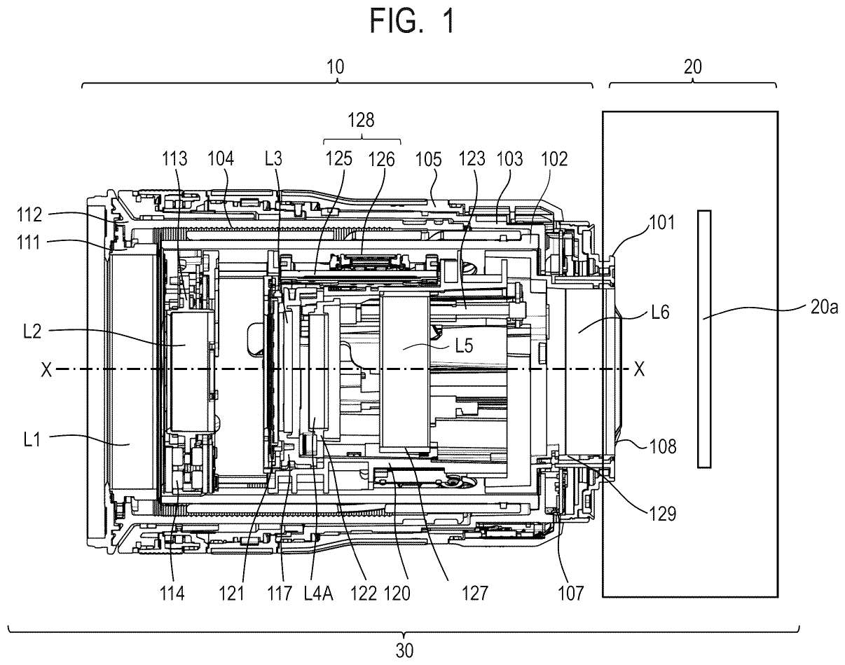

Preferred embodiments of the present invention will now be described in detail in accordance with the accompanying drawings. Hereinafter, a lens barrel 10 (optical apparatus) according to an embodiment 1 of the present disclosure and an imaging system 30 including the lens barrel 10 will be described. FIG. 1 is a cross-sectional view illustrating a configuration of the lens barrel 10 and a camera 20 constituting the imaging system 30 according to the embodiment 1 of the present disclosure. A chain line in the drawing indicates an optical axis X.

The camera 20 includes an image sensor 20a and is configured to be able to capture an image formed through the lens barrel 10.

The lens barrel 10 is provided with a mount 101, which can be connected and fixed to a mount (not shown) of the camera 20. A guide barrel 102 is fixed integrally to the mount 101 together with a fixed barrel 103. A cam ring 104 is held on the outer periphery of the guide barrel 102 so as to be freely rotatable around the optical axis. The cam ring 104 is connected to a zoom ring 105 rotatably held on the outer periphery of the guide barrel 102 by a key member (not shown) and is configured to be integrally rotated by operating the zoom ring 105 from the outside. The zoom sensor (not shown) is attached to the fixed barrel 103, is a sensor capable of electrically detecting the rotation angle of the zoom ring 105, is electrically connected to a control substrate 107 arranged in the vicinity of the mount 101 and transmits focal length information at the time of zooming to a control circuit. A contact block 108 is electrically connected to the control substrate 107 to communicate with the camera 20 and supply power.

A first lens unit L1 is fixed to a first lens barrel 111, and the first lens barrel 111 is fixed to a straight-proceeding barrel 112.

A second lens unit L2 is held by a second lens barrel 113, and the second lens barrel 113 is held by a shift unit 114 so as to be movable in a plane orthogonal to the optical axis X. The shift unit 114 includes an actuator for driving the second lens barrel 113, a sensor for detecting a driving amount, and the like, and is fixed to the guide barrel 102. The shift unit 114 is electrically connected to the control substrate 107. The control substrate 107 controls driving of the second lens barrel 113 so as to correct shake based on a shake signal detected by an angular velocity sensor (not shown) attached to the fixed barrel 103.

A third lens unit L3 is held by a third lens barrel 117 and is fixed to a third base lens barrel 120 (cylindrical member). An electromagnetic diaphragm unit 121 is held by the third base lens barrel 120 and is electrically connected to the control substrate 107.

A 4A lens unit L4A (first movable lens unit) is held by a 4A lens barrel 122 (first holding member), and the 4A lens barrel 122 is held by the third base lens barrel 120 by a guide member described later so as to be movable in the optical axis direction. The 4A lens unit L4A is a lens for focus adjustment, and the 4A lens barrel 122 holding the 4A lens unit L4A is driven in the optical axis direction by a linear vibration wave motor 128 (first driving unit) held by the third base lens barrel 120.

The linear vibration wave motor 128 includes a fixed portion 125 and a movable portion 126 and drives the movable portion 126 in the optical axis direction by ultrasonic vibration of a piezoelectric element, which is a well-known technique. The piezoelectric element is electrically connected to the control substrate 107 by a flexible printed board (not shown).

A fifth lens unit L5 is held by a fifth lens barrel 127 (another member) and is fixed to the third base lens barrel 120. A sixth lens unit L6 is held by a sixth lens barrel 129.

The first lens unit L1, the third lens unit L3, the fifth lens unit L5, and the sixth lens unit L6 are lenses that move for zooming, and cam followers (not shown) are fixed to the straight-proceeding barrel 112, the third base lens barrel 120, and the sixth lens barrel 129, respectively. Each cam follower is engaged with a straight groove provided in the guide barrel 102 and a cam groove provided in the cam ring 104 and is configured to be able to move straight in the optical axis direction by rotating the cam ring 104.

Further, since the 4A lens unit L4A for focus adjustment is held by the third base lens barrel 120, it is driven in the optical axis direction by the linear vibration wave motor 128 while moving together with the third base lens barrel 120 during zooming.

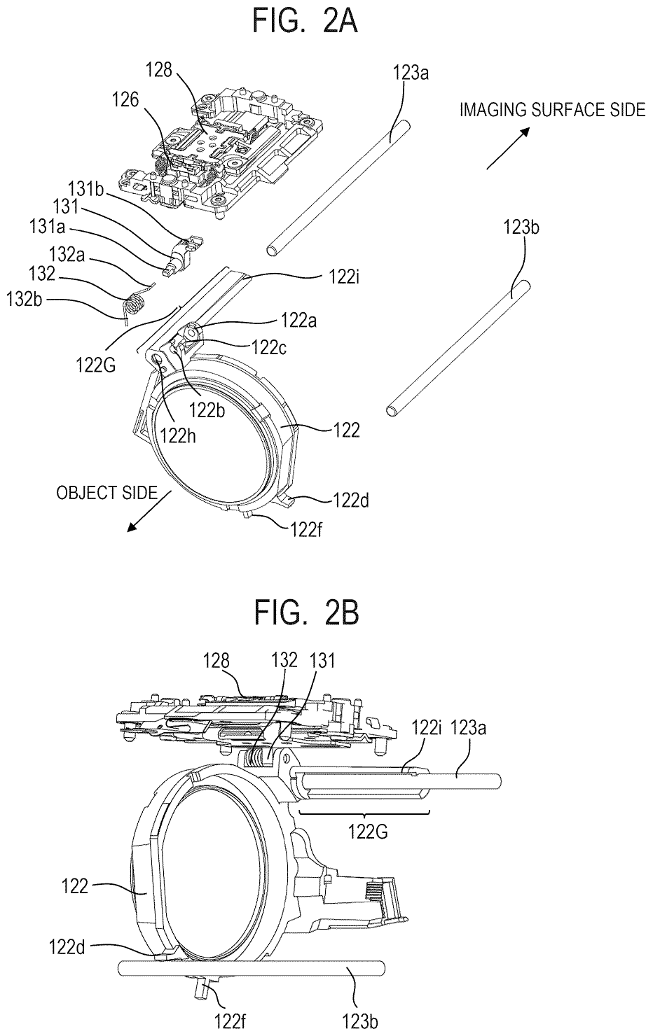

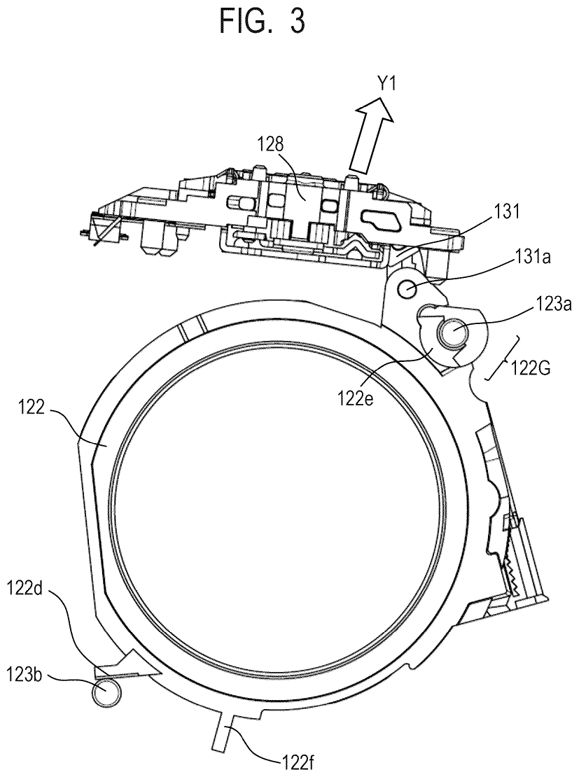

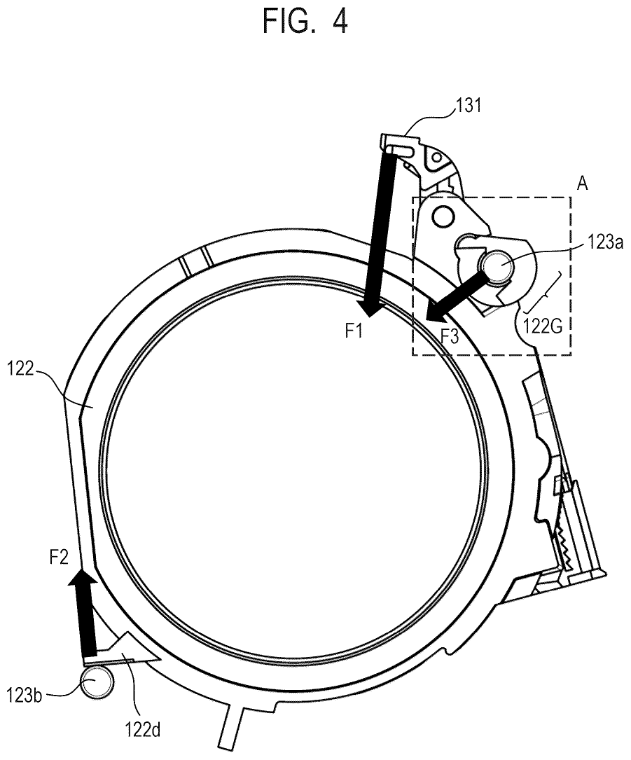

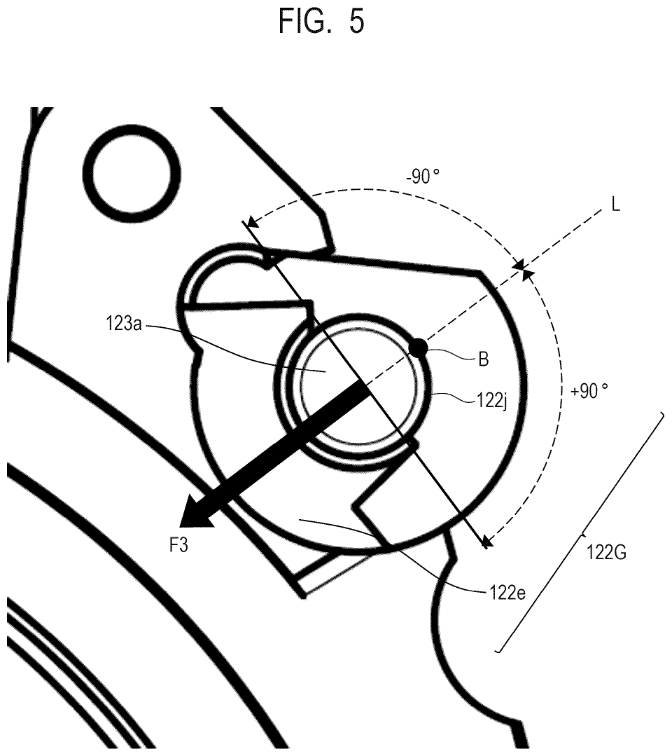

Next, a configuration for holding and a configuration for driving the 4A unit barrel 122 will be described. FIG. 2A is an exploded perspective view of the 4A lens barrel 122 and peripheral members. Further, FIG. 2B is a perspective view of a configuration in which peripheral members are assembled to the 4A lens barrel 122 viewed from another viewpoint. FIG. 3 is a front view of a configuration in which peripheral members are assembled to the 4A lens barrel 122 viewed from the imaging surface side. FIG. 4 is a front view illustrating forces acting on the 4A lens barrel 122 viewed from the image pickup surface side, and illustration of the linear vibration wave motor 128 is omitted. FIG. 5 is an enlarged view of a range A indicated by a broken line in FIG. 4.

A rack 131 (first coupling member) has an axis portion 131a, and the axis portion 131a is inserted into a rack spring 132 (first biasing member), the rack 131 is inserted between rack axis holes 122a and 122b of the 4A lens barrel 122 and is held rotatably around the axis of the axis portion 131a. And a hook portion 132a of the rack spring 132 is hooked on the rack 131, and an extension portion 132b on the opposite side is inserted into a spring hook hole 122c provided in the 4A lens barrel 122. With this configuration, the rack 131 is always biased in the direction of the arrow Y1 shown in FIG. 3 with the axis portion 131a as the center of rotation. And the rack 131 has a V-shaped groove portion 131b at the distal end thereof that is always engaged with a projection portion (not shown) provided on the movable portion 126 of the linear vibration wave motor 128. With this configuration, even if there is a variation in component accuracy, the rack 131 can transmit the driving force of the linear vibration wave motor 128 to the 4A lens barrel 122 without rattling by the urging force of the rack spring 132.

Both ends of each of a guide member 123a (first guide member) and a guide member 123b (second guide member) are fixed to the third base lens barrel 120. The guide member 123a engages with an engagement portion 122h with arc-shaped and an engagement portion 122i with arc-shaped of a linear guide portion 122G (first linear guide portion) provided in the 4A lens barrel 122, and guides and holds the 4A lens barrel 122 to be movable in the optical axis direction. A rotation regulating portion 122d (first regulating portion) of the 4A lens barrel 122 contacts the guide member 123b, thereby preventing the 4A lens barrel 122 from rotating around the guide member 123a. The rack spring 132 biases the 4A lens barrel 122 and the linear vibration wave motor 128 and biases the 4A lens barrel 122 and the guide member 123a.

Next, the shape of the 4A lens barrel 122 will be described. As described above, the 4A lens barrel 122 includes the linear guide portion 122G which contacts the guide member 123a and is guided along the guide member 123a serving as a first axis parallel to the optical axis X, and the rotation regulating portion 122d which contacts the guide member 123b. As shown in FIG. 3, FIG. 4, and FIG. 5, the linear guide portion 122G is not cylindrical but has a cutout portion 122e.

As described above, the rack 131 is always biased by the rack spring 132 in the direction indicated by the arrow Y1 in FIG. 3, and the linear vibration wave motor 128 is held by the third base lens barrel 120. Therefore, as shown in FIG. 4, the 4A lens barrel 122 receives a first force F1 applied to the 4A lens barrel 122 by the rack spring 132, which is parallel to the normal direction of the contact surface between the rack 131 and the linear vibration wave motor 128. Further, the 4A lens barrel 122 receives a second force F2 received by the rotation regulating portion 122d from the guide member 123b, which is parallel to the normal direction of the contact surface between the guide member 123b and the rotation regulating portion 122d. The first force F1 and the second force F2 form a resultant force F3, which biases the linear guide portion 122G against the guide member 123a.

A contact surface 122j (sliding surface) is formed on the linear guide portion 122G that slides with respect to the guide member 123a. The contact surface 122j exists in a range of +90 degrees (+90 degrees in the clockwise direction and −90 degrees in the counterclockwise direction) around the guide member 123a from an intersection B between a straight line L drawn from the center of the guide member 123a and the outer peripheral surface of the guide member 123a in the reaction direction of the resultant force F3. And in the linear guide portion 122G, the cutout portion 122e is formed in a range not including the contact surface 122j of the linear guide portion 122G viewed in the optical axis direction. According to this configuration, it is possible to stably bias the 4A lens barrel 122 to the guide member 123a even when the direction of gravity acting changes due to a change in the attitude of the imaging system 30.

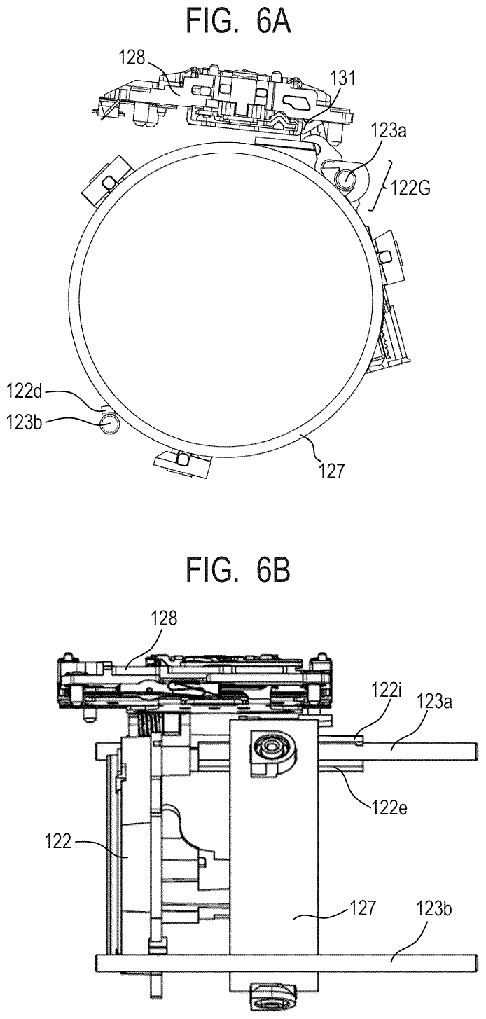

FIG. 6A is a front view of the arrangement of the 4A lens barrel 122 and the fifth lens barrel 127 viewed from the imaging surface side, and FIG. 6B is a side view of the same arrangement. As shown in FIG. 6A, the 4A lens barrel 122 and the fifth lens barrel 127 overlap in the optical axis direction, but a part of the guide member 123a or a part of the fifth lens barrel 127 can exist in the cutout portion 122e viewed in the optical axis direction by providing the cutout portion 122e in the linear guide portion 122G. Further, as shown in FIG. 6B, the guide member 123a or the fifth lens barrel 127 can be disposed so as to overlap the linear guide portion 122G viewed in a direction orthogonal to the optical axis. And other members such as the fifth lens barrel 127 can be disposed without escaping in the radial direction and the optical axis direction from the cutout portion 122e. According to the present embodiment having the above-described configuration, the optical apparatus achieves miniaturization while performing stable biasing in various attitudes.

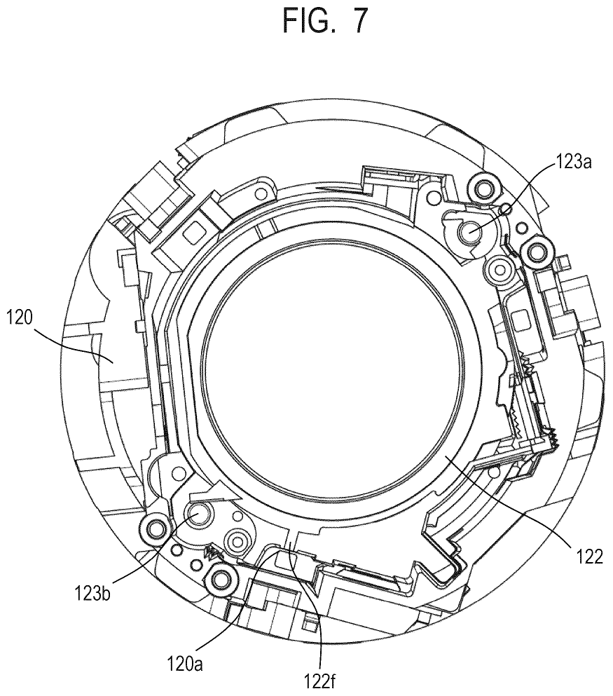

FIG. 7 is a front view of a configuration in which the 4A lens barrel 122 is assembled to the third base lens barrel 120 viewed from the imaging surface side. As shown in FIG. 7, the 4A lens barrel 122 further includes a rotation regulating portion 122f (third regulating portion), and the rotation regulating portion 122f regulates the rotation of the 4A lens barrel 122 in a direction away from the guide member 123b by a rotation regulating surface 120a of the third base lens barrel 120. Alternatively, the rotation regulating portion 122f comes into contact with the third base lens barrel 120 to which the guide member 123b is fixed to lock the rotation. Therefore, even when the lens barrel 10 receives an external force such as an impact, the 4A lens barrel 122 can be held without the rotation regulating portion 122d being largely separated from the guide member 123b.

### (Modification 1)

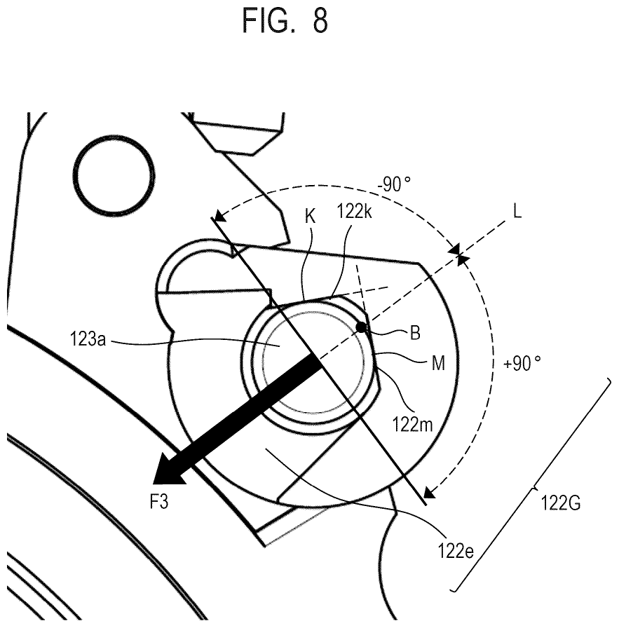

FIG. 8 is an enlarged view of a linear guide portion 122G illustrating a modification 1 of the linear guide portion 122G according to the embodiment 1. In the present embodiment, the engagement portions 122h and 122i of the linear guide portion 122G have an arc-shaped, but may have a shape having a sliding surface 122k (first sliding surface) and a sliding surface 122m (second sliding surface) including a straight line viewed from the optical axis direction as in the modification 1. Further, the linear guide portion 122G contacts the guide member 123a at a contact point K (first contact point) and a contact point M (second contact point) viewed in the optical axis direction, and an extension line of the sliding surface 122k including the contact point K and an extension line of the sliding surface 122m including the contact point M intersect with each other in a plane orthogonal to the optical axis.

At this time, the sliding surface 122k and the contact point K exist closer to the linear vibration wave motor 128 than the contact point M. The sliding surface 122k and the sliding surface 122m of the linear guide portion 122G exist in a range of +90 degrees around the guide member 123a from an intersection B between the straight line L drawn from the center of the guide member 123a and the outer peripheral surface of the guide member 123a in the reaction direction of the resultant force F3. That is, the sliding surface 122k and the contact point K exist in a range of −90 degrees from the intersection B in a direction approaching the linear vibration wave motor 128 (−90 degrees in the counterclockwise direction) about the center of the guide member 123a. Alternatively, the sliding surface 122m and the contact point M exist in a range of +90 degrees from the intersection B in a direction away from the linear vibration wave motor 128 (+90 degrees in the clockwise direction) about the center of the guide member 123a. With this configuration, even when the dimensions of the guide member 123a, the engagement portion 122h, and the engagement portion 122i are different from each other, the guide member 123a, the engagement portion 122h, and the engagement portion 122i can always come into contact with each other at the same two points viewed from the optical axis direction regardless of a change in the gravity direction due to a change in attitude.

### (Modification 2)

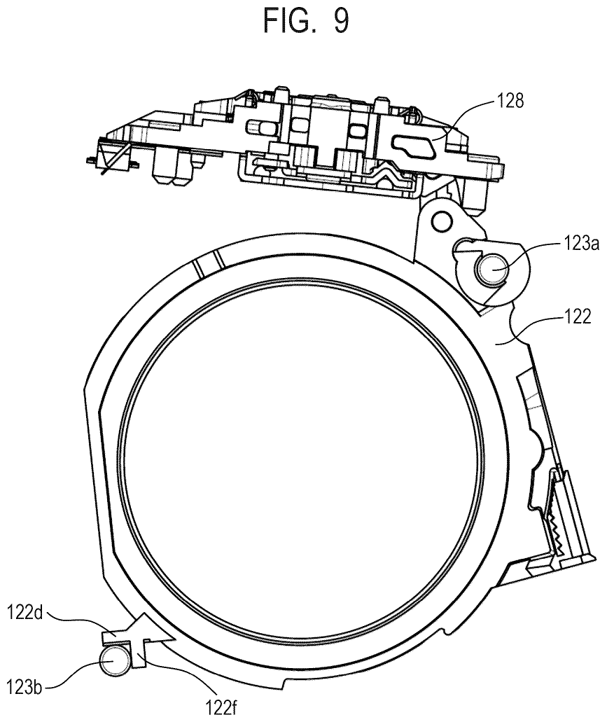

FIG. 9 is a front view illustrating a modification 2 of the rotation regulating portion 122f of the 4A lens barrel 122 according to the embodiment 1 viewed from the imaging surface side. In the present embodiment, the rotation regulating portion 122f is formed so as to contact the third base lens barrel 120 to regulate the rotation, but the rotation regulating portion 122f may contact the guide member 123b to lock the rotation as in the modification 2. As compared with the case where the rotation regulating portion 122f is provided to regulate the rotation of the third base lens barrel 120, the rotation can be regulated in a space saving manner.

### (Modification 3)

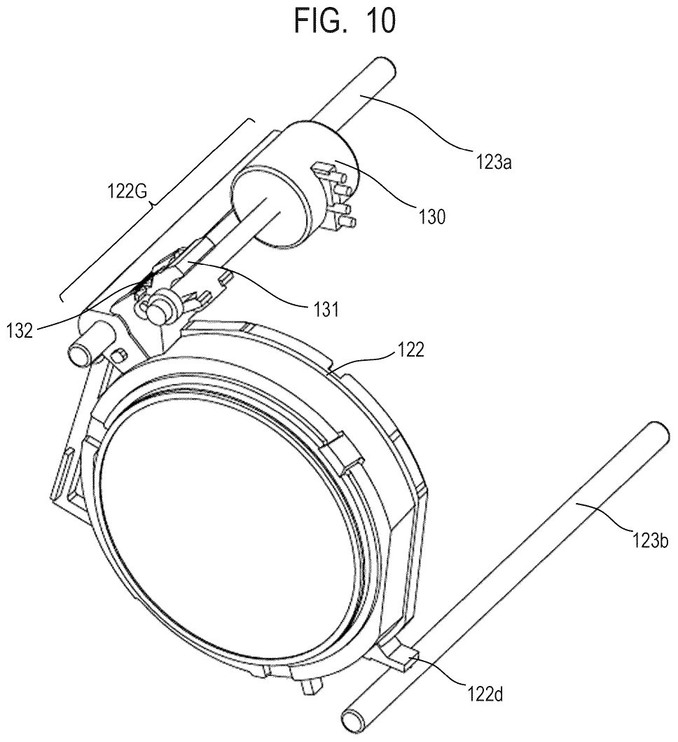

FIG. 10 is a perspective view illustrating a modification 3 of the driving unit of the 4A lens barrel 122 according to the embodiment 1. In the present embodiment, the linear vibration wave motor 128 is used to drive the 4A lens barrel 122. However, a similar effect can be obtained by using a driving unit such as a step motor 130 as in the modification 3.

### (Modification 4)

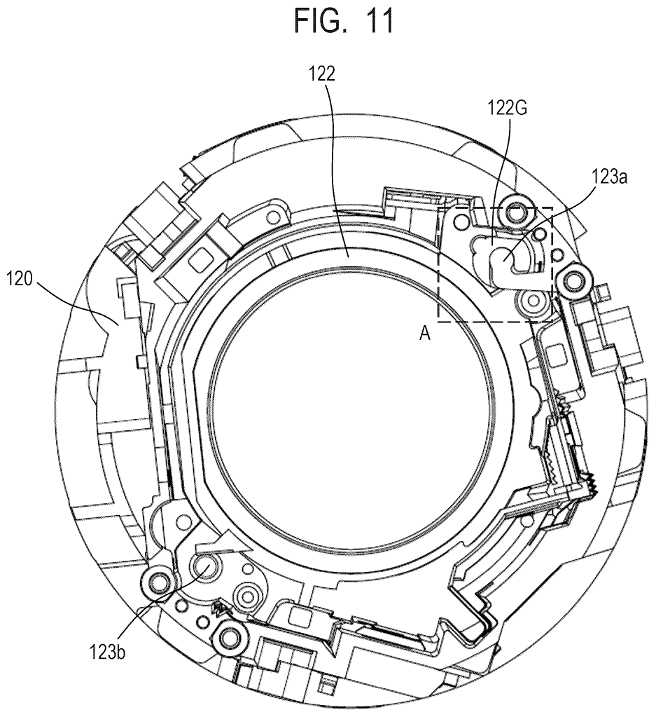

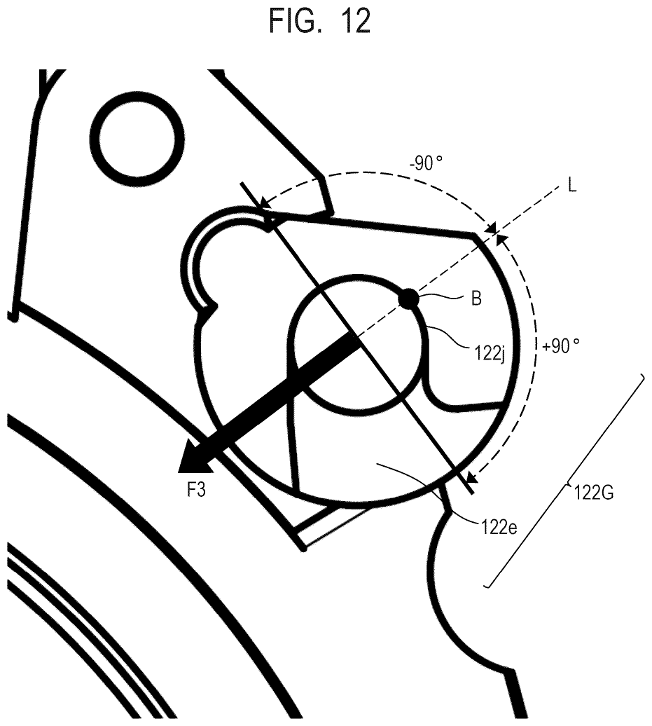

FIG. 11 is a front view illustrating a modification 4 of the guide member 123a according to the embodiment 1 viewed from the imaging surface side. In the present embodiment, a rod-shaped member is employed as the guide member 123a, but the guide member 123a may be configured integrally with the third base lens barrel 120 as in the modification 4. FIG. 12 is an enlarged view of a range A indicated by a broken line in FIG. 11, in which a guide member 123a formed integrally with the third base lens barrel 120 is omitted for easy understanding. The contact surface 122j between the linear guide portion 122G and the guide member 123a exists in a range of +90 degrees from the intersection B around the center of the guide member 123a as an axis, and the cutout portion 122e is formed in the linear guide portion 122G in a range other than the contact surface 122j so as not to interfere with the third base lens barrel 120. With this configuration, it is possible to reduce the cost by reducing the number of members and the number of assembly steps.

### Embodiment 2

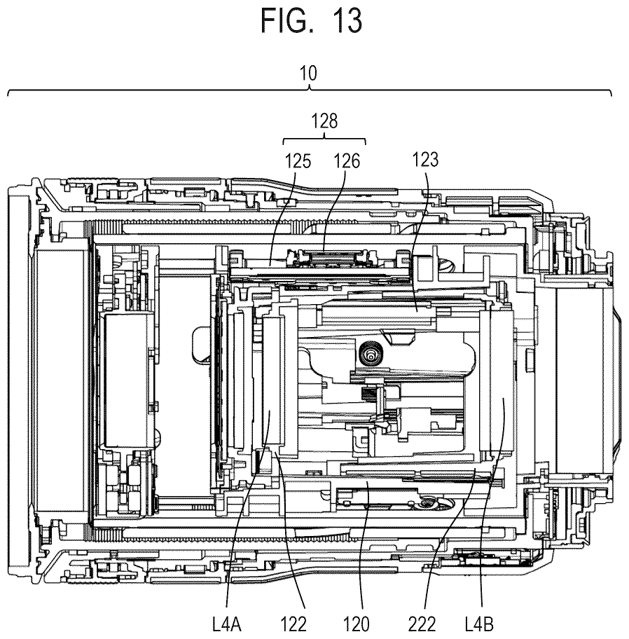

Hereinafter, the lens barrel 10 according to an embodiment 2 of the present disclosure will be described. FIG. 13 is a cross-sectional view illustrating a configuration of the lens barrel 10 according to the embodiment 2. In the embodiment 1, one 4A lens unit L4A is used as a lens for focus adjustment. However, in the present embodiment, two focus adjustment lenses of the 4A lens unit L4A and a 4B lens unit L4B (second movable lens unit) are used. In comparison with the embodiment 1, the same components in the embodiment 2 are denoted by the same reference numerals, and the description thereof will be omitted.

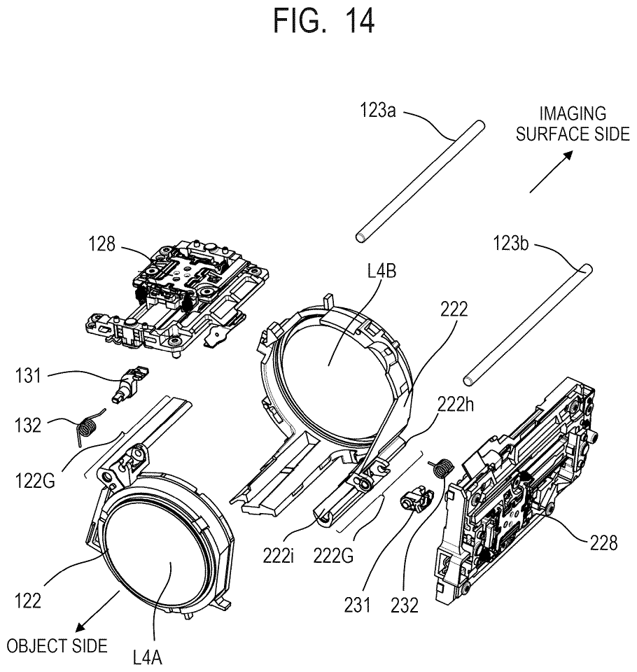

FIG. 14 is an exploded perspective view of the 4A lens barrel 122, a 4B lens barrel 222 (second holding member), and peripheral members. The 4B lens unit L4B is held by the 4B lens barrel 222, and the 4B lens barrel 222 is held by the third base lens barrel 120 (not shown) by a guide member 123b so as to be movable in the optical axis direction. The 4B lens unit L4B is a lens for focus adjustment similarly to the 4A lens unit L4A, and the 4B lens barrel 222 holding the 4B lens unit L4B is driven in the optical axis direction by a linear vibration wave motor 228 (second driving unit) held by the third base lens barrel 120. Since the configuration of the linear vibration wave motor 228 is the same as that of the linear vibration wave motor 128 described in the embodiment 1, the description thereof will be omitted.

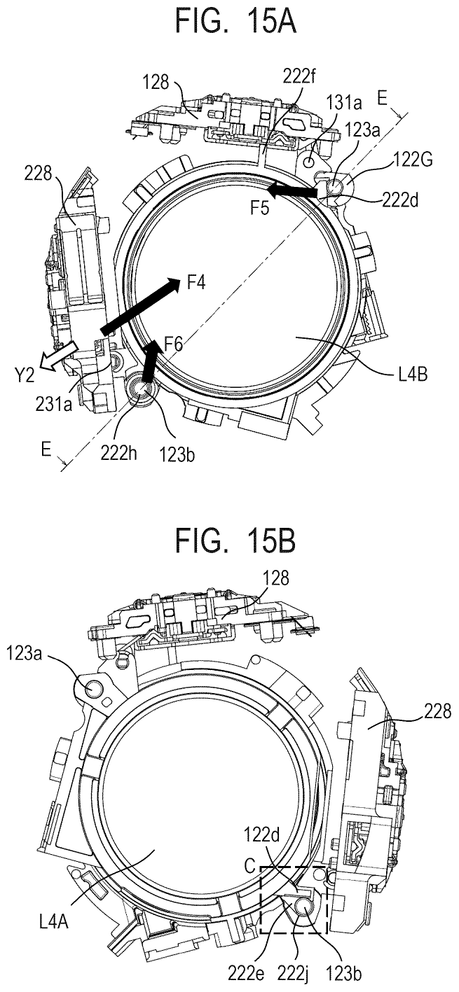

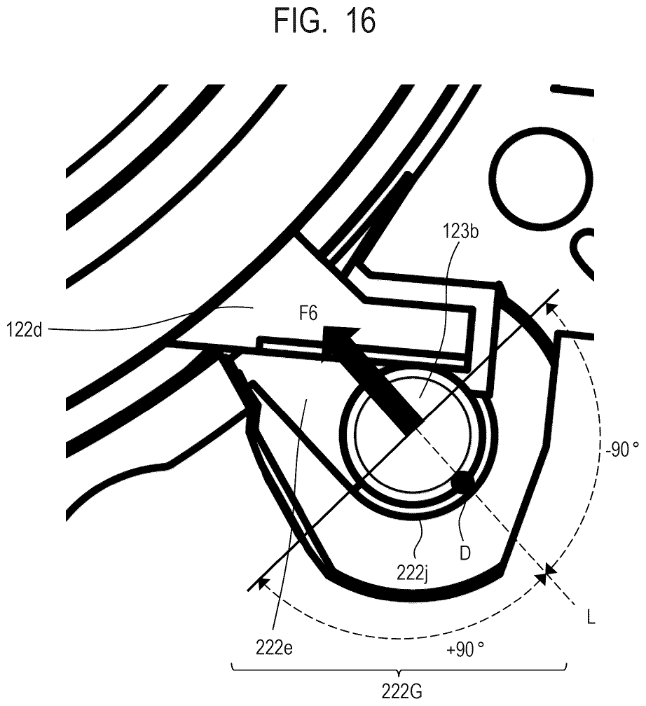

FIG. 15A is a front view of a configuration in which the 4A lens barrel 122 and the 4B lens barrel 222 are assembled to the peripheral members viewed from the imaging surface side, and FIG. 15B is a front view viewed from the object side. FIG. 16 is an enlarged view of a range C indicated by a broken line in FIG. 15B.

In the 4B lens barrel 222, the driving force of the linear vibration wave motor 228 is transmitted to the 4B lens barrel 222 by a rack 231 (second coupling member) and a rack spring 232 (second biasing member), similarly to the 4A lens barrel 122 of the embodiment 1.

The guide member 123a engages with the engagement portions 122h, 122i with the arc-shaped of the linear guide portion 122G provided in the 4A lens barrel 122 and holds the 4A lens barrel 122 movably in the optical axis direction. At the same time, a rotation regulating portion 222d (second regulating portion) provided in the 4B lens barrel 222 contacts the guide member 123a. At the same time that the rotation regulating portion 122d contacts the guide member 123b, engagement portions 222h, 222i with the arc-shaped of a linear guide portion 222G (second linear guide portion) provided in the 4B lens barrel 222 engage, and the 4B lens barrel 222 is guided and held so as to be freely movable in the optical axis direction. The rotation regulating portion 222d of the 4B lens barrel 222 contacts the guide member 123a, thereby preventing the 4B lens barrel 222 from rotating around the guide member 123a. In addition, the rack spring 232 biases the 4B lens barrel 222 and the linear vibration wave motor 228, and biases the 4B lens barrel 222 and the guide member 123b.

An axis portion 231a of the rack 231 exists in a region where the axis portion 131a of the rack 131 exists among regions divided by a line (cross-sectional line E-E in FIG. 15A) connecting the centers of the guide member 123a and 123b viewed from the optical axis direction. The rack spring 232 also biases so that the contact point between the rotation regulating portion 222d and the guide member 123a exists in the same region as the axis portion 231a.

Next, the shape of the 4B lens barrel 222 will be described. As described above, the 4B lens barrel 222 includes the linear guide portion 222G which contacts the guide member 123b and is guided along the guide member 123b serving as the second axis parallel to the optical axis X, and the rotation regulating portion 222d which contacts the guide member 123a. As shown in FIG. 15B, the linear guide portion 222G is not cylindrical like the linear guide portion 122G but has a cutout portion 222e.

The rack 231 is constantly biased by the rack spring 232 in a direction indicated by an arrow Y2 illustrated in FIG. 15A, and the linear vibration wave motor 228 is held by the third base lens barrel 120. Therefore, as shown in FIG. 15A, the 4B lens barrel 222 receives a fourth force F4 parallel to the normal direction of the contact surface between the rack 231 and the linear vibration wave motor 228. Further, 4B lens barrel 222 receives a fifth force F5 parallel to the normal direction of the contact surface between the guide member 123a and the rotation regulating portion 222d. The linear guide portion 222G is biased against the guide member 123b by a resultant force F6.

A contact surface 222j (sliding surface) is formed on the linear guide portion 222G that slides with respect to the guide member 123b. The contact surface 222j exists in a range of ±90 degrees (+90 degrees in the clockwise direction and −90 degrees in the counterclockwise direction) from an intersection D of the straight line L drawn from the center of the guide member 123b and the outer peripheral surface of the guide member 123b in the reaction direction of the resultant force F6. And in the linear guide portion 222G, the cutout portion 222e is formed in a range not including the contact surface 222j of the linear guide portion 222G viewed in the optical axis direction. With this configuration, it is possible to stably bias the 4B lens barrel 222 to the guide member 123b even when the direction of gravity acting changes due to a change in the attitude of the imaging system 30.

The cutout portion 222e is formed so as to accommodate the rotation regulating portion 122d of the 4A lens barrel 122 viewed from the optical axis direction. The rotation regulating portion 222d is formed so as to be accommodated in the cutout portion 122e of the 4A lens barrel 122.

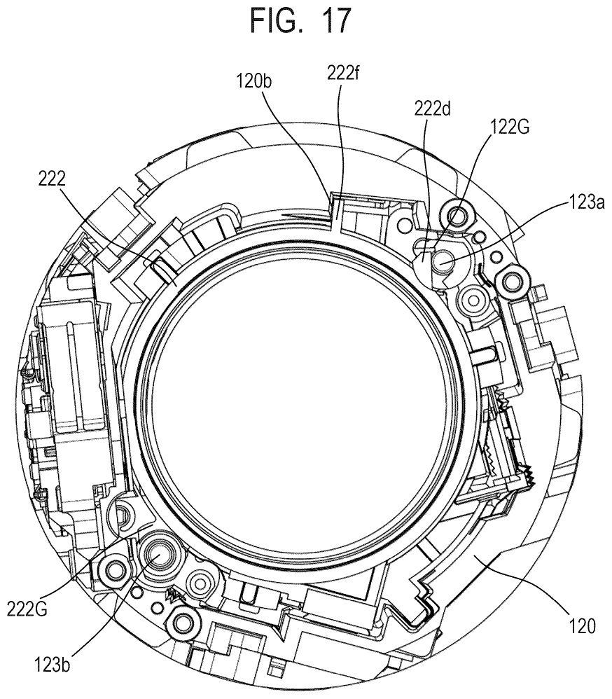

FIG. 17 is a front view of a configuration in which the 4A lens barrel 122 and the 4B lens barrel 222 are assembled to the third base lens barrel 120 viewed from the imaging surface side. As shown in FIG. 17, the 4B lens barrel 222 further includes a rotation regulating portion 222f, and the rotation regulating portion 222f regulates the rotation of the 4B lens barrel 222 in a direction away from the guide member 123a by a rotation regulating surface 120b of the third base lens barrel 120. Therefore, even when the lens barrel 10 receives an external force such as an impact, the 4B lens barrel 222 can be held without the rotation regulating portion 222d being largely separated from the guide member 123a.

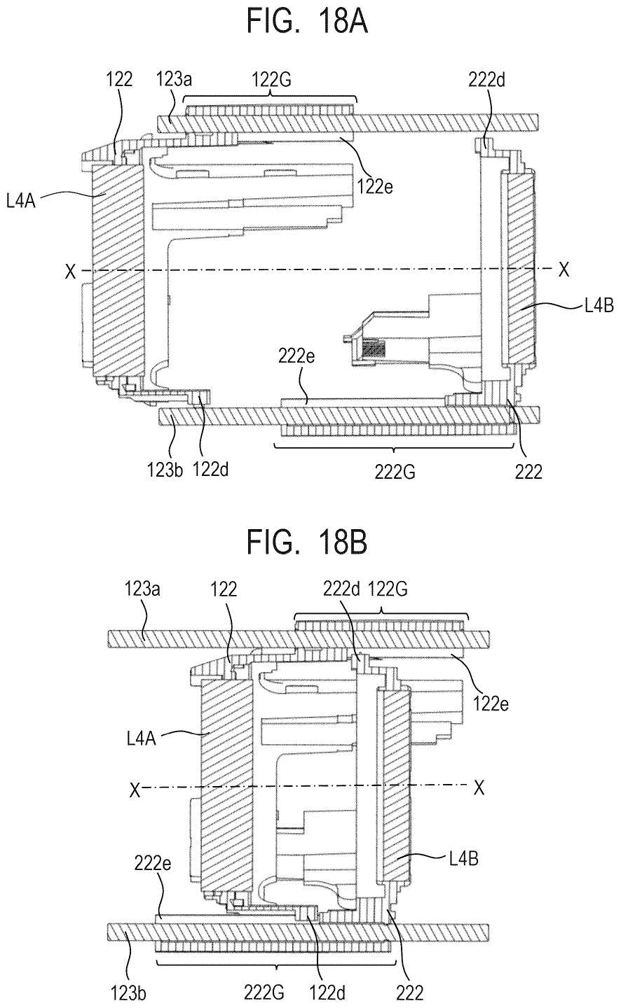

FIG. 18A is a cross-sectional view taken along a cross-sectional line E-E illustrated in FIG. 15A in a state where the distance between the 4A lens barrel 122 and the 4B lens barrel 222 is maximum in the optical axis direction. FIG. 18B is a cross-sectional view in a state where the distances are minimum. These cross-sectional views illustrate cross-sections of the 4A lens barrel 122, the 4B lens barrel 222, the guide member 123a, and the guide member 123b taken along a line (E-E) connecting the centers of the guide member 123a and the guide member 123b.

As shown in FIG. 18B, at least when the 4A lens barrel 122 and the 4B lens barrel 222 are close to each other in the optical axis direction, the rotation regulating portion 222d overlaps in a plane orthogonal to the axes of the linear guide portion 122G and the guide member 123a. Further, by configuring the 4A lens barrel 122 and the 4B lens barrel 222 as in the present embodiment, it is possible to arrange these members such that the 4A lens barrel 122 and the 4B lens barrel 222 overlap each other viewed from the direction orthogonal to the optical axis.

With this configuration, since the 4A lens barrel 122 and the 4B lens barrel 222 are held by the same guide member 123a and guide member 123b, it is possible to achieve both a compact configuration in the radial direction and a reduction in the entire length of the apparatus, and it is possible to reduce the size of the lens barrel 10.

### (Modification 5)

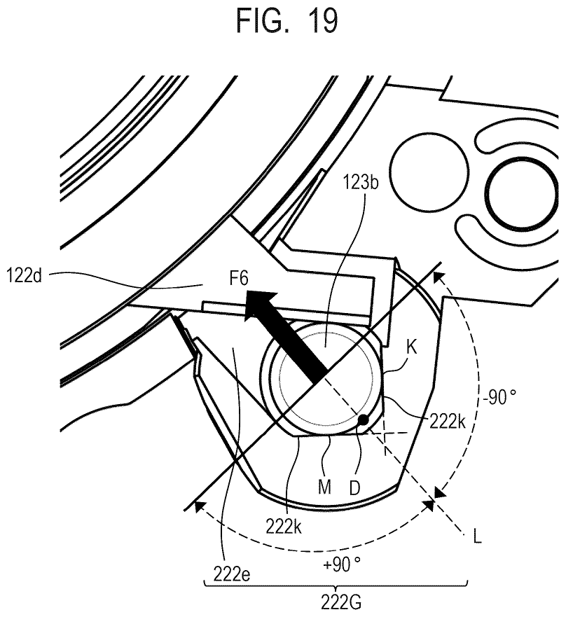

FIG. 19 is an enlarged view of a linear guide portion 222G illustrating a modification 5 of the linear guide portion 222G in the embodiment 2. In the present embodiment, the engagement portions 222h and 222i of the linear guide portion 222G have an arc-shaped, but may have a shape having a sliding surface 222k (third sliding surface) and a sliding surface 222m (fourth sliding surface) including a straight line viewed from the optical axis direction as in the modification 5. Further, the linear guide portion 222G contacts the guide member 123b at the contact point K (third contact point) and the contact point M (fourth contact point) viewed in the optical axis direction, and extension lines of the sliding surface 222k including the contact point K and the sliding surface 222m including the contact point M intersect with each other on a plane orthogonal to the optical axis.

At this time, the sliding surface 222k and the contact point K exist closer to the linear vibration wave motor 228 than the contact point M. The sliding surface 222k and the sliding surface 222m of the linear guide portion 222G exist in a range of +90 degrees around the guide member 123b from the intersection D between the straight line L drawn from the center of the guide member 123b and the outer peripheral surface of the guide member 123b in the reaction direction of the resultant force F6. That is, the sliding surface 222k and the contact point K exist in a range of −90 degrees from the intersection D in the direction approaching the linear vibration wave motor 228 (−90 degrees in the counterclockwise direction) about the center of the guide member 123b. Alternatively, the sliding surface 222m and the contact point M exist in a range of +90 degrees from the intersection D in a direction away from the linear vibration wave motor 228 (+90 degrees in the clockwise direction) about the center of the guide member 123b. With this configuration, even when the dimensions of the guide member 123b, the engagement portion 222h, and the engagement portion 222i are different from each other, the guide member 123b, the engagement portion 222h, and the engagement portion 222i can always come into contact with each other at the same two points viewed from the optical axis direction regardless of a change in the gravity direction due to a change in attitude.

In the present embodiment, the rotation regulating portion 122f is provided so as to contact the third base lens barrel 120 to regulate the rotation but may be configured so as to contact the guide member 123b to regulate the rotation. Further, although the rotation regulating portion 222f is provided so as to contact the third base lens barrel 120 to regulate the rotation, but it may be configured to contact the guide member 123a to regulate the rotation.

### (Modification 6)

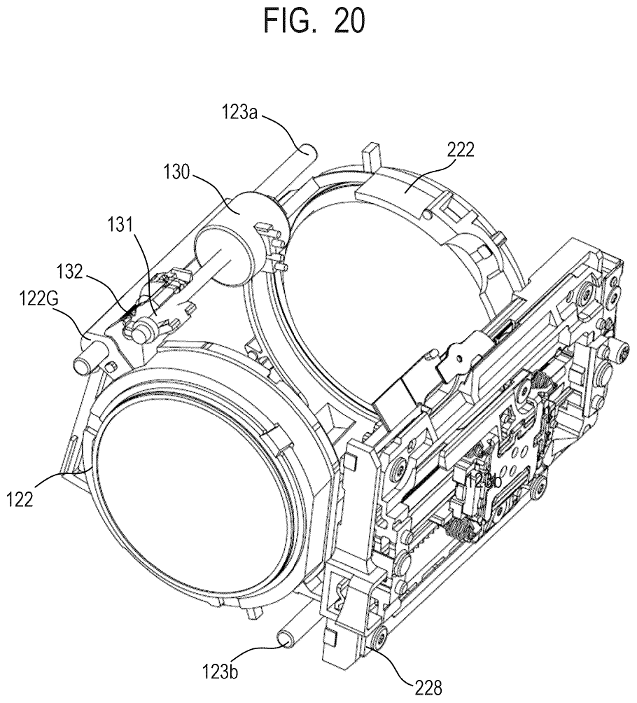

FIG. 20 is a perspective view illustrating a modification 6 of the driving unit of the 4A lens barrel 122 according to the embodiment 2. In the present embodiment, the linear vibration wave motor is used to drive the 4A lens barrel 122 and the 4B lens barrel 222. However, a similar effect can be obtained even when a driving unit such as the step motor 130 is used for one of them as in the modification 6. It goes without saying that a stepping motor or the like may be adopted for both driving unit.

Although the preferred embodiments of the present disclosure have been described above, the present disclosure is not limited to these embodiments, and various modifications and changes can be made within the scope of the gist of the present disclosure.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-207791, filed Dec. 8, 2023, which is hereby incorporated by reference herein in its entirety.

What is claimed is:

1. An optical apparatus comprising:
a first holding member configured to hold a first movable lens unit,
a first guide member and a second guide member that guide the first holding member in an optical axis direction,
a first driving unit configured to drive the first holding member in the optical axis direction,
a first coupling member configured to transmit a driving force of the first driving unit to the first holding member, and
a first biasing member configured to bias the first holding member and the first driving unit and to bias the first holding member and the first guide member,
wherein the first holding member includes a first linear guide portion which contacts the first guide member and is guided along a first axis parallel to an optical axis, and a first regulating portion which contacts the second guide member,
wherein a sliding surface of the first linear guide portion that slides with respect to the first guide member exists in a range of +90 degrees around the first axis from an intersection between a straight line drawn from a center of the first axis and an outer peripheral surface of the first guide member in a reaction force direction of a resultant force formed by a first force applied to the first holding member by the first biasing member and a second force received by the first regulating portion from the second guide member,
wherein the first linear guide portion has a cutout portion in a range not including the sliding surface viewed in the optical axis direction,
wherein a part of the first guide member or another member exists in the cutout portion viewed in the optical axis direction, and
wherein the first guide member or the other member is disposed so as to overlap the first linear guide portion viewed in a direction orthogonal to the optical axis.

2. The optical apparatus according to claim 1,
wherein the first linear guide contacts the first guide member at a first contact point and a second contact point viewed in the optical axis direction,
wherein an extension line of a first sliding surface of the first linear guide portion including the first contact point and an extension line of a second sliding surface of the first linear guide portion including the second contact point intersect with each other in a plane orthogonal to the optical axis,
wherein the first contact point is closer to the first driving unit than the second contact point and exists between the intersection and 90 degrees in a direction approaching the first driving unit with the center of the first guide member as an axis, alternatively, or the second contact point exists between the intersection and 90 degrees in a direction away from the first driving unit with the center of the first guide member as an axis.

3. The optical apparatus according to claim 1, further comprising:
a second holding member configured to hold a second movable lens unit,
a second driving unit configured to drive the second holding member in the optical axis direction, and
a second coupling member configured to transmit a driving force of the second driving unit to the second holding member,
wherein the second holding member includes a second linear guide portion that is guided in the optical axis direction, and a second regulating portion that contacts against the first guide member, and
wherein at least when the first holding member and the second holding member are close to each other in the optical axis direction, the second regulating portion overlaps the first linear guide portion in a plane orthogonal to the first axis.

4. The optical apparatus according to claim 3,
wherein a second biasing member configured to bias the second holding member and the second driving unit and to bias the second holding member and the second guiding member,
wherein the second linear guide contacts the second guide member at a third contact point and a fourth contact point viewed in the optical axis direction, and
wherein a third sliding surface of the second linear guide portion including the third contact point and a fourth sliding surface of the second linear guide portion including the fourth contact point have extension lines that intersect with each other on a plane orthogonal to the optical axis.

5. The optical apparatus according to claim 1, wherein the first regulating portion prevents the first holding member from rotating around the first guide member by coming into contact with the second guide member.

6. The optical apparatus according to claim 3, wherein the second regulating portion prevents the second holding member from rotating around the first guide member by coming into contact with the first guide member.

7. The optical apparatus according to claim 1, wherein the first holding member is provided with a third regulating portion that regulates separation of the first holding member from the second guiding member.

8. The optical apparatus according to claim 7, wherein rotation of the third regulating portion is stopped by a cylindrical member to which the second guide member is fixed.

9. The optical apparatus according to claim 7, wherein rotation of the third regulating portion is stopped by the second guide member.

10. An image pickup apparatus comprising:
an optical apparatus, and
an imaging element configured to capture an image formed by the optical apparatus,
the optical apparatus comprising:
a first holding member configured to hold a first movable lens unit,
a first guide member and a second guide member that guide the first holding member in an optical axis direction,
a first driving unit configured to drive the first holding member in the optical axis direction,
a first coupling member configured to transmit a driving force of the first driving unit to the first holding member, and
a first biasing member configured to bias the first holding member and the first driving unit and to bias the first holding member and the first guide member,
wherein the first holding member includes a first linear guide portion which contacts the first guide member and is guided along a first axis parallel to an optical axis, and a first regulating portion which contacts the second guide member,
wherein a sliding surface of the first linear guide portion that slides with respect to the first guide member exists in a range of +90 degrees around the first axis from an intersection between a straight line drawn from a center of the first axis and an outer peripheral surface of the first guide member in a reaction force direction of a resultant force formed by a first force applied to the first holding member by the first biasing member and a second force received by the first regulating portion from the second guide member,
wherein the first linear guide portion has a cutout portion in a range not including the sliding surface viewed in the optical axis direction,
wherein a part of the first guide member or another member exists in the cutout portion viewed in the optical axis direction, and
wherein the first guide member or the other member includes an optical apparatus disposed so as to overlap the first linear guide portion viewed in a direction orthogonal to the optical axis.
